(19) United States
(12) Patent Application Publication
(10) Pub. No.: US 2011/0061760 A1
(43) Pub. Date: Mar. 17, 2011

(54) CONDUITS AND COUPLING SYSTEMS FOR TRENCHLESS APPLICATIONS

(75) Inventors: Sébastien Gauthier, La Prairie (CA); Robert Laflamme, Verdun (CA)

(73) Assignee: IPEX Technologies Inc., Mississauga (CA)

(21) Appl. No.: 12/877,398

(22) Filed: Sep. 8, 2010

Related U.S. Application Data
(60) Provisional application No. 61/241,983, filed on Sep. 14, 2009.

(51) Int. Cl. F16L 9/00

(52) U.S. Cl. 138/177

(57) ABSTRACT

A conduit for trenchless applications is provided. The conduit comprises a first coupler region on one end of the conduit and a second coupler region on the other end of the conduit. The first coupler region is configured to be attached to a second coupler region of another conduit, while the second coupler region is configured to be attached to a first coupler region of another conduit. The first and second coupler regions can engage a sealing member and, optionally, a locking member.

### PRIORITY

The present application hereby claims the benefit of priority, under 35 U.S.C. §119(e), to U.S. Provisional Patent Application Ser. No. 61/241,983, filed on Sep. 14, 2009, and entitled “CONDUITS AND COUPLING SYSTEMS FOR TRENCHLESS APPLICATIONS.” Said Provisional Application is hereby incorporated by reference herein in its entirety.

### FIELD

The present disclosure generally relates to conduits and, more particularly, relates to conduits configured to be used in trenchless applications.

### BACKGROUND

It is frequently necessary or desirable to install underground pipe or conduit (together referred to as “conduit”) without digging a fully open trench for placing the conduit. In installing new conduit and/or replacing existing conduit in an urban area, it is often desirable to place the conduit beneath an obstacle, such as a road or a building, for example, where it is not practical to dig an open trench into which the conduit could be placed. In other applications, conduit can be installed without digging an open trench between one or more manholes, for example. When the obstacles is a road, it may not be practical to interrupt traffic flow for a time sufficient to dig an open trench across the road, install the conduit, backfill the open trench, and replace the road. When the obstacle is a building, the building usually cannot be moved or removed for obvious reasons and, as such, open trenches usually cannot be dug in these situations.

In these instances, one pit can be dug on each side of the obstacle. These pits can be used in place of the traditional open trenches used by conventional conduit installation and replacement systems. The pits can be aligned with the location, or proposed location, of ends of the conduit or conduits requiring installation or replacement. In such instances, a new or replacement conduit can be installed by pushing or pulling the conduit through the soil or existing conduit beneath the obstacle and between the first pit and the second pit or between a first manhole and second manhole, for example. The first and second manholes can function in a similar manner as the first and second pits.

One of these conduit “pushing” or “pulling” systems is known as pipe bursting. In a pipe bursting operation, an expander head can be inserted into an existing conduit from within a first pit. The expander head is used to break or grind the existing conduit into many small pieces and push the small pieces outwardly into the soil as the expander head is advanced through the conduit. In a pipe bursting operation in which the conduit is pushed (“pushing pipe bursting operation”), a new conduit section can be attached to the expander head such that as the expander head is pushed or advanced from the first pit, through the void formed by the existing conduit, toward and/or into the second pit, the new conduit section can be pushed with the expander head along the void and, thereby, situated into the proper position. In a pipe bursting operation in which the conduit is pulled (“pulling pipe bursting operation”), a new conduit section can be attached to the expander head such that as the expander head is pulled from the first pit, through the void formed by the existing conduit, and toward and/or into the second pit, the new conduit section can be pulled along the void and, thereby, situated into the proper position. Additional conduit sections can be attached to the new conduit section and, likewise, pulled along as the expander head is advanced through the existing conduit to form an appropriate length of conduit between the first pit and the second pit or between the first and second manholes.

Another conduit “pushing” system is known as microtunnelling. In a microtunnelling operation, a first pit is dug on a first side of an obstacle and a second pit is dug on a second side of the obstacle. In some embodiments, the pits can also be existing manholes. In one embodiment, a cutting head is advanced through soil or rock from the first pit toward the second pit. The cutting head can comprise blades and/or cutting members configured to bore and/or cut through soil and/or rock. A first section of conduit is attached to a portion of the cutting head such that that first section is advanced through the bore created by the cutting head as the cutting head is advanced from the first pit toward the second pit. As the cutting head is advanced, a second section of conduit can be attached to the first section of conduit, a third section of conduit can be attached to the second section of conduit, and so forth, to form an appropriate length of conduit extending between the first pit and the second pit or between the first and second manholes.

Another of the conduit “pulling” systems is known as sliplining or a tight-in-pipe system (together referred to as “sliplining”). In a sliplining operation, a first pit is dug on one side of an obstacle and a second pit is dug on the other side of the obstacle in a similar fashion as that described above. In some embodiments, the pits can also be existing manholes. In one embodiment, sliplining operations can comprise a cable or other elongate member being inserted into and through an existing conduit that needs to be replaced and/or that is leaking. The cable can extend from the first pit or manhole, through the existing conduit, and into the second pit or manhole. A cable retracting device can be operatively engaged with the cable such that the cable retracting device can retract the cable from the second pit toward and/or into the first pit. Before the cable is retracted, however, a new conduit section can be attached to the cable within the second pit, such that the new conduit section can be pulled through the existing conduit toward the first pit. The new conduit section can generally have a smaller outer perimeter than the inner perimeter of the existing conduit. As the new conduit section is pulled through the existing conduit, additional sections of new conduit can be attached to the new conduit section engaged with the cable to form the length of conduit. As a result, a length of new conduit formed by the conduit sections can be positioned entirely through the existing conduit positioned between the first and second pits or the first and second manholes.

In these sliplining operations, a minimal gap can be formed between the outer perimeter of the new conduit sections and the inner perimeter of the existing conduit. In one embodiment, the gap can be about 4 mm, for example, which can provide about an 8 mm difference between the outer perimeter of the new conduit sections and the inner perimeter of the existing conduit. This limited spacing between the outer perimeter of the new conduit sections and the inner perimeter of the existing conduit can at least reduce the new conduit sections from moving within the existing conduit (i.e., conduit floating) once pulled into the proper position. Also, by providing the minimal space, the replacement conduit can have a flow capacity that is similar to the existing conduit and, sometimes, can even gain flow capacity when taking into consideration that the existing conduit has often deteriorated, thereby possibly reducing its flow capacity. In some instances, a grout or filler material, such as a mix of hydraulic cement and water in various ratios, for example, can be inserted into the space between the outer perimeter of the new conduit sections and the inner perimeter of the existing conduit to at least reduce the chance that the new conduit sections will move within the existing conduit once pulled into the proper position.

In view of the importance of these various trenchless systems for replacing and/or installing conduits, the conduits used with these systems should be improved.

### SUMMARY

In one non-limiting embodiment, the present disclosure, in part, is directed to conduits having uniform or substantially uniform outer and inner perimeters, even in regions of the conduits where one conduit section is attached to another conduit section (i.e., coupler regions). The coupler regions, when attached to each other, can form an outer perimeter which is the equal to, substantially equal to, or less than an outer perimeter of non-coupler regions of the conduits to create essentially profileless coupler regions on the outer surfaces of the conduits. As a result, the conduits of the present disclosure can reduce the drag and/or frictional forces placed on the conduits during installation. The coupler regions, when attached to each other, can also form an inner perimeter which is the equal to, substantially equal to, or less than an inner perimeter of the non-coupler regions of the conduits to create essentially profileless coupler regions on inner surfaces of the conduits. Such features can at least reduce hindrances to liquid flow within the conduits.

In another non-limiting embodiment, the present disclosure, in part, is directed to a coupling system for conduits comprising a locking member configured to be engaged with portions of coupler regions of the conduits. The locking member can be shaped and configured to at least partially transfer some of an axial tensile force applied to the coupler regions during installation to other portions of the conduits, thereby allowing the joined conduits to, in most instances, withstand the axial tensile loads encountered. As a result, the locking member of the present disclosure can at least reduce the chance that the joined conduits will be pulled apart during a conduit pulling installation or replacement. The locking member can also assist in keeping the conduits properly aligned and coupled in the hole or bore, after installation, under conditions of varying temperature. This feature can, in some instances, lead to reduced leakage of fluids into and out of the conduits, for example.

In yet another non-limiting embodiment, the present disclosure, in part, is directed to a tubular conduit configured for trenchless applications. The tubular conduit comprises an inner surface defining a bore through at least a portion of the tubular conduit, an outer surface, a tubular conduit wall having a thickness defined between a portion of the inner surface and a portion the outer surface, a first end, a second end, a first coupler region positioned proximate to the first end of the tubular conduit, and a second coupler region positioned proximate to the second end of the tubular conduit and distal from the first coupler region. The first coupler region comprises a first outer circumferential surface that has a perimeter that is smaller than a perimeter of the outer surface of the tubular conduit, and a first circumferential groove defined in the first outer circumferential surface that is configured to receive a portion of a locking member. The first circumferential groove is located a distance X1 from the first end. The first coupler region comprises a second circumferential groove defined in the first outer circumferential surface that is configured to receive a portion of a sealing member. The second circumferential groove is located a distance X2 from the first end and the distance X1 is greater than the distance X2. The first coupler region comprises a first inner circumferential surface and a first coupler region wall having a first thickness defined between the first outer circumferential surface and the first inner circumferential surface. The second coupler region comprises a second inner circumferential surface having an inner perimeter that is larger than the perimeter of the first outer circumferential surface of the first coupler region, such that a first outer circumferential surface of a first coupler region of another tubular conduit is configured to fit at least partially within the second inner circumferential surface of the second coupler region. The second coupler region comprises a circumferentially extending receiving slot defined in the second inner circumferential surface and positioned proximate to the second end. The receiving slot is configured to receive a portion of the locking member. The second coupler region comprises a second outer circumferential surface and a second coupler region wall having a second thickness defined between the second outer circumferential surface and the second inner circumferential surface. The sum of the first thickness and the second thickness is less than or substantially equal to the thickness of the tubular conduit wall.

In still another non-limiting embodiment, the present disclosure, in part, is directed to a conduit configured for trenchless applications. The conduit comprises an inner surface defining a bore through at least a portion of the conduit, an outer surface, a conduit wall having a thickness defined between a portion of the inner surface and a portion the outer surface, a first coupler region positioned proximate to a first end of the conduit, and a second coupler region positioned proximate to a second end of the conduit and distal from the first coupler region. The first coupler region comprises a first outer coupler surface that has a perimeter that is smaller than a perimeter of the outer surface of the conduit and a first groove defined in the first outer coupler surface that is configured to receive a portion of a first sealing member. The first groove is located a first distance from the first end. The first coupler region comprises a second groove defined in the first outer coupler surface that is configured to receive a portion of a second sealing member. The second groove is located a second distance from the first end and the first distance is greater than the second distance. The first coupler region comprises a first inner coupler surface and a first coupler region wall having a first thickness defined between the first outer coupler surface and the first inner coupler surface. The second coupler region comprises a second inner coupler surface having an inner perimeter that is larger than the perimeter of the first outer coupler surface of the first coupler region, such that a first outer coupler surface of a first coupler region of another conduit is configured to fit at least partially within the second inner coupler surface of the second coupler region. The second coupler region comprises a second outer coupler surface and a second coupler region wall having a second thickness defined between the second outer coupler surface and the second inner coupler surface. The sum of the first thickness and the second thickness is less than or substantially equal to the thickness of the conduit wall. The second coupler region comprises a chamfered region positioned proximate to the second end. The second coupler region wall has a minimum thickness at the second end owing to the chamfered region.

In still another non-limiting embodiment, the present disclosure, in part, is directed to a coupling system configured for use in trenchless applications that is configured to allow coupling of a first conduit to a second conduit. The system comprises the first conduit comprising a first coupler region comprising a first end, a first shoulder, a first outer coupler surface defined intermediate the first end and the first shoulder, a first inner coupler surface, a first coupler region wall having a first thickness defined between the first outer coupler surface and the first inner coupler surface, a first groove defined in the first outer coupler surface and positioned distal from the first end, a second groove defined in the first outer coupler surface and positioned proximate to the first end, and a third groove defined in the first outer coupler surface intermediate the first groove and the second groove. The system comprises a locking member. A portion of the locking member is configured to be positioned in the first groove. The system comprises a first sealing member and a second sealing member. A portion of the first sealing member is configured to be positioned in the second groove and a portion of the second sealing member is configured to be positioned in the third groove. At least one of the first sealing member and the second sealing member has a D-shaped cross-sectional profile. The system comprises the second conduit comprising a second coupler region comprising a second end, a second shoulder, a second outer coupler surface defined intermediate the second end and the second shoulder, a second inner coupler surface, and a receiving slot defined in the second inner coupler surface. The receiving slot is configured to receive a portion of the locking member. The second coupler region comprises a second coupler region wall having a second thickness defined between the second outer coupler surface and the second inner coupler surface. The sum of the first thickness and the second thickness is less than or substantially equal to a thickness of a non-coupler region of the first conduit or the second conduit such that the first and second coupler regions of the first conduit and the second conduit are substantially flush with an outer surface of the first conduit and an outer surface of the second conduit when the first conduit is engaged with the second conduit.

### BRIEF DESCRIPTION OF DRAWINGS

The above-mentioned and other features and advantages of the present disclosure, and the manner of attaining them, will become more apparent and the disclosure itself will be better understood by reference to the following description of non-limiting embodiments of the disclosure taken in conjunction with the accompanying drawings, wherein:

FIG. 1 is a schematic illustration of an example trenchless application for conduits;

FIG. 2 is an exploded perspective view of two conduits and a coupling system in accordance with one non-limiting embodiment;

FIG. 3 is a perspective view of the two conduits and the coupling system of FIG. 2 with sealing members and a locking member positioned on a first coupler region of the first conduit in accordance with one non-limiting embodiment;

FIG. 4 is a perspective view of the two conduits of FIG. 3 coupled to each other in accordance with one non-limiting embodiment;

FIG. 5 is a cross-sectional view of the engagement of the locking member of FIG. 3 to a portion of a first coupler region of the first conduit and a portion of a second coupler region of the second conduit in accordance with one non-limiting embodiment;

FIG. 5A is a cross-sectional view of the locking member taken along line 5A-5A of FIG. 2 in accordance with one non-limiting embodiment;

FIG. 6 is a cross-sectional view of the sealing member taken along line 6-6 of FIG. 2 in accordance with one non-limiting embodiment;

FIG. 7 is a cross-sectional view of the first and second coupler regions taken along a portion of line 7-7 of FIG. 4 in accordance with one non-limiting embodiment;

FIG. 8 is an exploded perspective view of two conduits and a coupling system in accordance with one non-limiting embodiment; and

FIG. 9 is a perspective view of the two conduits and the coupling system of FIG. 8 with sealing members and a locking member positioned on a first coupler region of the first conduit in accordance with one non-limiting embodiment.

### DETAILED DESCRIPTION

Various non-limiting embodiments of the present disclosure will now be described to provide an overall understanding of the principles of the structure, function, manufacture, and use of the conduits and coupling systems disclosed herein. One or more examples of these non-limiting embodiments are illustrated in the accompanying drawings. It will be appreciated that the conduits and coupling systems specifically described herein and illustrated in the accompanying drawings are non-limiting example embodiments and that the scope of the various non-limiting embodiments of the present disclosure are defined solely by the claims. The features illustrated or described in connection with one non-limiting embodiment can be combined with the features of other non-limiting embodiments. Such modifications and variations are intended to be included within the scope of the present disclosure.

Conduit can be installed or replaced using trenchless operations through conduit pushing systems, conduit pulling systems, and/or other suitable systems. These systems can comprise the appropriate machinery for such tasks. In general, a first pit can be dug on one side of an obstacle, under which the conduit must be installed and/or replaced, and a second pit can be dug on the other side of the obstacle. In some installations, preexisting manholes can be used in place of the first and second pits. In conduit pushing or pulling systems, conduits sections can be attached to one another during the pushing or the pulling to form a suitable length of conduit. Owing to the small dimensions of the first and second pits or manholes, use of sectional conduits is usually appropriate. In one embodiment, an individual section of conduit can be in the range of about two feet to about ten feet in length, and can be about three feet in length, for example. One key with using these sectional conduits is the need to couple the conduits together in an appropriate manner to form a suitable length of conduit for a particular application. Some coupler regions of conventional conduit sections have outer perimeters that are larger than outer perimeters of non-coupler regions of the conduit sections. As a result, these coupler regions of the conduit sections may catch, drag, and/or create significant friction while they are being installed through soil, rock, and/or an existing conduit, for example.

Generally, a hole, bore, or void made by the conduit pushing and/or pulling systems is not much larger than a new conduit being installed. As a result, any protrusions, such as coupler regions of conventional conduits, for example, extending outwardly with respect to an outer surface of non-coupler regions of the conventional conduits being installed, can create a hindrance and a significant drag or frictional force as the conventional conduits are being pushed or pulled through the hole. To reduce such hindrances, drag, and/or frictional forces, the conduits of the present disclosure can have a uniform or substantially uniform outer perimeter, even in regions of the conduits where one conduit section is attached to another conduit section (i.e., coupler regions), as discussed herein. The conduits of the present disclosure can also have a uniform or substantially uniform inner perimeter, even in the coupler regions of the conduits.

Another issue with conventional conduit coupling systems and/or conventional coupler regions is that during a pulling installation or replacement, the conventional conduits can sometimes be pulled apart at the coupler regions. Such pulling apart can occur owing to high axial tensile loads applied to the coupler regions during the pulling installation or replacement. To alleviate such issues, in one embodiment, a coupling system for conduits can comprise a locking member configured to be engaged with portions of the coupler regions of the conduits, as discussed herein.

In various embodiments, the conduits of the present disclosure can comprise any shape and/or size suitable for carrying or transporting wires, fiber optic cables, water, natural gas, oil, and/or sewage, for example. Those of skill in the art will recognize that any other suitable material, liquid, slurry, and/or gas can also be carried or transported. The term “conduit” as used herein can comprise more than one conduit, a section of conduit, and/or a section of conduit configured to be coupled to another section of conduit. In various embodiments, the conduit can comprise a round, ovate, square, rectangular, pentagonal, hexagonal, heptagonal, octagonal, and/or triangular cross-sectional shape or profile. In other embodiments, the conduit can comprise an arcuate portion and/or can comprise any other suitable cross-sectional shape or profile. Those of skill in the art will recognize that the conduit can also have other suitable cross-sectional shapes and/or profiles. In any event, the conduit can comprise a bore therethrough.

In various embodiments, the conduit can be comprised of any suitable materials, such as clay, cement, concrete and/or reinforced concrete, steel, cast iron, polypropylene, polyethylene, polyvinyl chloride (PVC), plastic, a polymer, acrylonitrile-butadiene-styrene (ABS), and/or other suitable materials. In one embodiment, the conduit can have any suitable diameter, such as diameters in the range of about four inches to about forty-two inches, for example. The conduit of the present disclosure can be used in conduit pulling systems, such as sliplining systems and pulling pipe bursting systems, for example, conduit pushing systems, such as microtunnelling and pushing pipe bursting systems, for example, a combination of conduit pulling and conduit pushing systems, and/or any other suitable trenchless installation systems known to those of skill in the art. Depending on which installation system is being used, the conduits can comprise various configurations, sizes, shapes, profiles, lengths, diameters, wall thicknesses, and/or materials, for example.

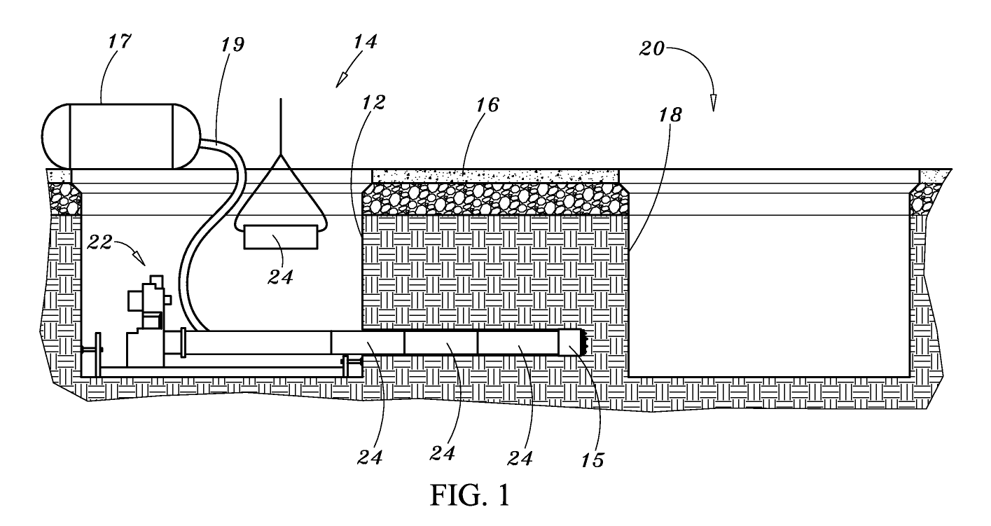

In one embodiment, referring to FIG. 1, an example “pushing” trenchless application system 10 for conduit replacement or installation is illustrated. This example trenchless system can be a microtunnelling operation, for example. A first pit 12 can be dug on a first side 14 of a road 16 and a second pit 18 can be dug on a second side 20 of the road 16. A machine 22 can be lowered, usually by a crane, into the first pit 12. The machine 22 can comprise a portion having a cutting head 15 configured to bore through soil and rock under the road 16 (or other obstacle). A vacuum apparatus 17 can be in communication with a portion of the machine 22 through tube 19 to remove the soil and rock cut by the cutting head 15. This machine 22 can be used to push or pull the conduit 24 through the ground or through an existing conduit. These machines 22 are commercially sold or rented by TT Technologies or Vermeer Pacific, for example. In general, conduit sections 24 are usually lowered into the first pit 12, but can also be lowered into the second pit 18 in some circumstances. The conduit sections 24 can have a length suitable to fit within the first pit 12 and/or the second pit 18 in a horizontal orientation. One of the conduits sections 24 can be engaged with a portion of the machine 22 and/or the cutting head 15 such that the conduit section 24 can be pulled or pushed through the hole created by the cutting head 15 of the machine 22 or the existing conduit. The additional conduit sections 24 can be attached to the conduit section 24 engaged with the machine 22 and/or the cutting head 15 such that a length of conduit can be installed or replaced between the first pit 12 and the second pit 18.

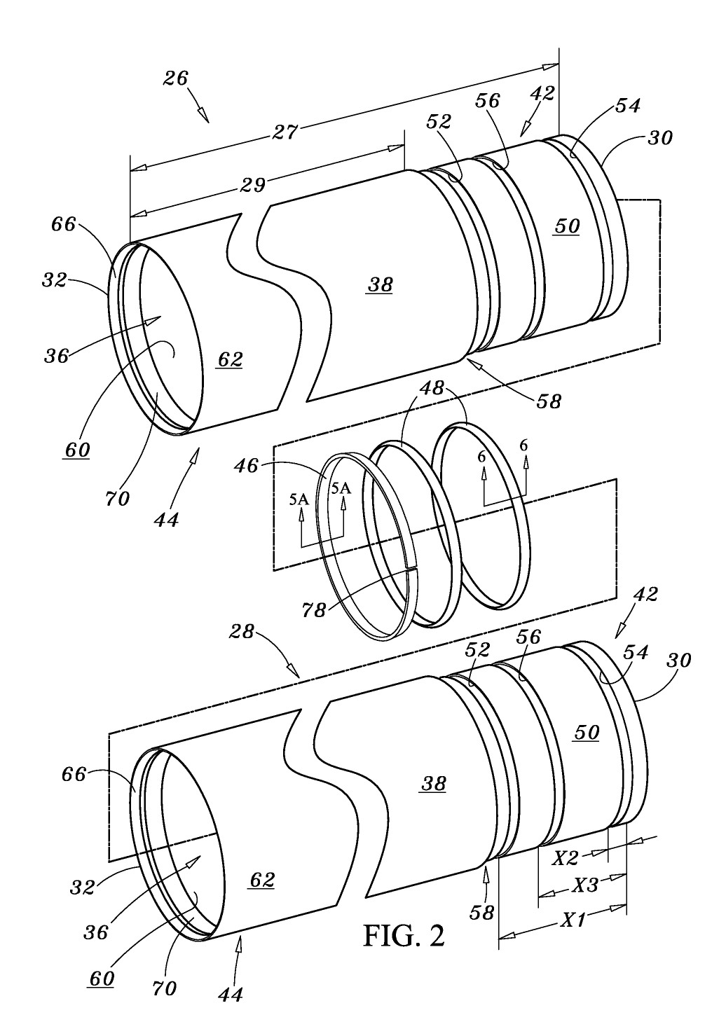

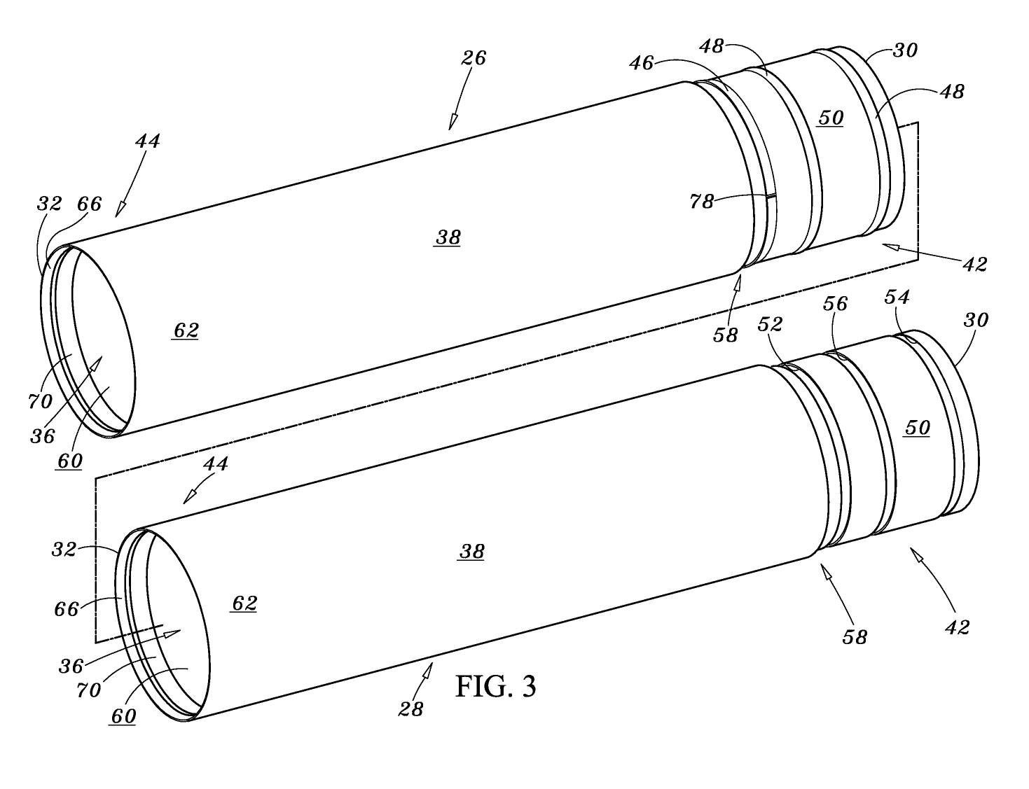

In various embodiments, the conduits of the present disclosure can be used with the above-described conduit installation or replacement systems, can be used with other conduit replacement or installation systems, and/or can be used for any other suitable purpose, for example. In one embodiment, referring to FIGS. 2, 3, 5, and 7, a first conduit or tubular conduit 26 and a second conduit or tubular conduit 28 are illustrated. The first conduit 26 and the second conduit 28 can each have a total length 27 and a usable length 29, which is the total length 27 minus the length of a first coupler region of each of the first and second conduits 26 and 28. The usable length 29 is the length of each of the first and second conduits 26 and 28 that form a material-engaging outer perimeter of the first and second conduits 26 and 28 (i.e., the portions of the first and second conduits 26 and 28 that form the outer surface when engaged on each end with other conduits). Each of the first and second conduits 26 and 28 can comprise a first end 30, a second end 32, an inner surface 34 defining a bore 36 through at least a portion of the tubular conduits 26 and 28, an outer surface 38, a conduit wall or tubular conduit wall 40 having a thickness defined between a portion of the inner surface 34 of the first and second conduits 26 and 28 and a portion of the outer surface 38 of the first and second conduits 26 and 28. Each of the first and second conduits 26 and 28 can also comprise a first coupler region 42 and a second coupler region 44. In one embodiment, a conduit (not illustrated) can be provided with only one of the first coupler region 42 or the second coupler region 44 for specific applications, such as end portions of a length of conduit. The first and second coupler regions 42 and 44, in conjunction with one or more optional locking members 46 and one or more sealing members 48, can be used to couple the first conduit 26 to the second conduit 28. In one embodiment, the locking member and the one or more sealing members can be a single component, instead of separate components. In other embodiments, only the locking member 46 can be provided, for example. Of course, the first and second coupler regions 42 and 44 of numerous conduits can also be used to couple the second conduit 28 to a third conduit, the third conduit to a fourth conduit, and so forth. It will be understood by those of skill in the art that as many conduits can be connected as appropriate for a particular application. In various embodiments, the coupler regions 42 and 44 can allow the first conduit 26 to be joined to the second conduit 28, locked to, or substantially locked to, the second conduit 28 via the locking member 46, and/or sealed to, or substantially sealed to, the second conduit 28 via the one or more sealing members 48.

In one embodiment, still referring to FIGS. 2, 3, 5, and 7, the first coupler region 42 on each of the first and second conduits 26 and 28 can comprise a first outer circumferential surface or outer coupler surface 50 that has a perimeter that is smaller than a perimeter of the outer surface 38 of the first and second conduits 26 and 28, such that the first outer coupler surface 50 is radially recessed from the outer surface 38. A first coupler region wall 43 can have a first thickness defined between the first outer coupler surface 50 and a first inner coupler surface or first inner circumferential surface 45. A first groove or circumferential groove 52 can be defined in the first outer coupler surface 50 and can be configured to receive a portion of the locking member 46. In one embodiment, the locking member 46 and/or the first groove 52 can be optional. The first groove 52 can be located a distance X1 from the first end 30 of each of the first and second conduits 28 and 30. The first coupler region 42 can also comprise a second groove or circumferential groove 54 defined in the first outer coupler surface 50. The second groove 54 can be configured to receive a portion of one of the sealing members 48 and can be located a distance X2 from the first end 30. In various embodiments, the distance X1 can be greater than the distance X2. In one embodiment, a third groove or circumferential groove 56 can also be defined in the first outer coupler surface 50. In various embodiments, the third groove 56 can be configured to receive a portion of a second locking member (not illustrated) or one of the sealing members 48. In one embodiment, the third groove 56 can be located a distance X3 from the first end 30, where the distance X3 can be less than the distance X1, but can be greater than the distance X2. As a result, the third groove 56 can be located intermediate the first groove 52 and the second groove 54. Like the first groove 52, the third groove 56 can be optional in one embodiment. In various embodiments, only one groove can be formed in the first outer coupler surface 50. In such an embodiment, the single groove can be configured to receive a component that functions as a locking member and a sealing member, for example. In one embodiment, the various grooves 52, 54, and/or 56 can extend partially or fully around the first outer coupler surface 50.

In various embodiments, the first coupler region 42 can comprise a shoulder 58, such as an annular shoulder, for example, positioned most distal from the first end 30. The shoulder 58 can comprise a surface, such as a flat surface, for example, extending in an outward radial direction perpendicular to or substantially perpendicular to the first outer coupler surface 50. In other various embodiments, the surface of the shoulder 58 can extend in a radial direction, other than perpendicular to or substantially perpendicular to the first outer coupler surface 50. One of the purposes of the shoulder 58 can be to create an abutting portion to receive or be positioned proximate to the second end 32 of the second coupler region 44, as discussed in further detail herein. Without the shoulder 58, in some instances, the second coupler region 44 could be slid over the first outer coupler surface 50 of the first coupler region 42 further than required or appropriate during coupling of the first conduit 26 to the second conduit 28. In other various embodiments, the shoulder 58 can be eliminated and the first coupler region 42 and the second coupler region 44 can be tapered, for example. In such an embodiment, the first coupler region 42 can have its smallest outer perimeter near the first end 30 and its largest outer perimeter on a side of the first groove 52 most distal from the first end 30, for example. In such an instance, the second coupler region 44 can have its largest inner perimeter near the second end 32 and its smallest inner perimeter on an end of the second coupler region 44 most distal from the second end 32. In such an embodiment, the second coupler region 44 can be slid over the first coupler region 42 as required or as appropriate, without over sliding, owing to the tapered regions. Those of skill in the art will recognize that other members, components, and/or features configured to prevent, or at least inhibit, over sliding of the second coupler region 44 over the first coupler region 42 can also be used to accomplish a similar result.

In one embodiment, again referring to FIGS. 2, 3, 5, and 7, the second coupler region 44 on each of the first and second conduits 26 and 28 can comprise a second inner coupler surface or second inner circumferential surface 60 having an inner perimeter that is larger than a perimeter of the first outer coupler surface 50 of the first coupler region 42. In such an embodiment, the second coupler region 44 of the second conduit 28 can be slid or moved over the first outer coupler surface 50 of the first coupler region 42 of the first conduit 26, for example. The second coupler region 44 can comprise a second outer coupler surface 62 and a second coupler region wall 64 having a second thickness defined between the second outer coupler surface 62 and the second inner coupler surface 60. The sum of the first thickness of the first coupler region wall 43 and the second thickness of the second coupler region wall 64 can be less than, equal to, or substantially equal to the thickness of the conduit wall 40, such that the first and second coupler regions 42 and 44, when engaged with each other, may not extend outwardly with respect to the outer surface 38 of the conduit wall 40, or extend only to a limited extent with respect to the outer surface 38 of the conduit wall 40, and may not extend inwardly with respect to the inner surface 34 of the conduit wall 40, or extend only to a limited extent with respect to the inner surface 34. In one embodiment, the first and second coupler regions 42 and 44, when engaged with each other, may be substantially flush with respect to the outer surface 38 of the conduit wall 40 and with respect to the inner surface 34 of the conduit wall 40.

In various embodiments, referring to FIGS. 2, 3, 4, 5, and 7, the second coupler region 44 can comprise a chamfered region 66, such as an annular chamfered region, for example, proximate to the second end 32, and to some extent forming the second end 32. The chamfered region 66 can comprise a first inner perimeter at a location on the chamfered region 66 distal from the second end 32 and a second inner perimeter at a location on the chamfered region 66 proximal to the second end 32. In various embodiments, the first inner perimeter can be smaller than the second inner perimeter, thereby creating the chamfered region 66. In one embodiment, the chamfered region 66 can be angled about 5 to about 50 degrees, about 10 to about 30 degrees, or about 15 degrees relative to a plane of the second inner coupler surface 60 of the second coupler region 44. The chamfered surface of the chamfered region 66 can extend fully or partially around the second inner coupler surface 60 of the second coupler region 44 proximate to the second end 30. As a result, the second coupler region wall 64 can have a minimum thickness at the second end 32 owing to the chamfered region 66. In one embodiment, the chamfered region 66 can be slid over a top portion of the locking member 46 during sliding of the second coupler region 44 over the first coupler region 42 owing to an angled or sloped top portion of the locking member 46, as discussed in further detail herein. In various embodiments, the chamfered region 66 can also be slid over outer surfaces of the one or more sealing members 48 to at least reduce the chance that the one or more sealing members 48 could be cut or broken by the second end 32 during assembly of the first conduit 26 to the second conduit 28, for example. The second coupler region 44 can comprise a shoulder 68, such as an annular shoulder, for example, configured to be abutted with, or positioned proximate to, the first end 30 when the second coupler region 44 is slid over the first coupler region 42. The shoulder 68 can be similar to the shoulder 58 except that the shoulder 68 can extend radially inwardly toward the inner surface 34, as compared to the shoulder 58 which extends radially outwardly from the first outer coupler surface 50. The shoulder 68 can comprise a surface, such as a flat surface, for example, configured to be abutted with the first end 30 to at least inhibit over sliding of the second coupler region 44 over the first coupler region 42.

In one embodiment, referring to FIGS. 2, 3, 5, and 7, the second inner coupler surface 60 of the second coupler region 44 can comprise a receiving slot 70 configured to receive a portion of the locking member 46. The receiving slot 70 can comprise a first receiving slot wall 72 and at least a second receiving slot wall 74. The angle formed at the intersection of the first receiving slot wall 72 and the second receiving slot wall 74 can be an acute angle, a right angle, or an obtuse angle. In one embodiment, the first receiving slot wall 72 can extending inwardly from the second inner coupler surface 60 of the second coupler region 44 and can comprise a first portion spaced a first distance from the second inner coupler surface 60, and a second portion spaced a second distance from the second inner coupler surface 60. The second distance can be at least twice as great as the first distance, and the second portion can be located closer to the second end 32 than the first portion. In one embodiment, the depth from the second inner coupler surface 60 to the first receiving slot wall 72 of the receiving slot 70 can increase based on the proximity of a portion of the first receiving slot wall 72 to the second end 32. In one embodiment, the receiving slot 70 can be configured to receive at least an angled portion of the locking member 46 such that the first conduit 26 and the second conduit 28 are at least inhibited from pulling apart owing to a portion of the locking member 46 most proximal to the second end 32 engaging the second receiving slot wall 74 at least when an axial tensile force is applied to the first and second coupler regions 42 and 44 during a pulling operation or installation, for example, and such that the conduits 26 and 28 are maintained at least substantially coupled and aligned under varying temperature conditions. In various embodiments, the portion of the locking member 46 can fit somewhat loosely within the receiving slot 70 such that it can have some limited movement within the receiving slot 70. Such limited movement can allow the first conduit 26 to move relative to the second conduit 28 while the one or more sealing members 48 remain in a sealed position. This feature can be useful at least when the ground surrounding the first and second conduits 26 and 28 changes temperature, for example.

In one embodiment, referring to FIGS. 2, 3, 5, 5A, and 7, the locking member 46 can comprise a circular, substantially circular, ovate, arcuate, or semi-circular shape, for example. While described as a “locking” member, the locking member 46 can also act as a seal and can be comprised of a resilient, semi-resilient, and/or a semi-rigid material, for example. In one embodiment, the locking member 46 may not form a fully enclosed shape. Stated another way, the locking member 46 can have a gap 78 formed therein. The gap 78 can allow for easy installation of the locking member 46 into the first groove 52, or any other various groove in the first coupler region 42, by separation of end portions of the locking member 46 proximate to the gap 78 to expand an inner perimeter of the locking member 46 and allow the locking member 46 to fit over at least a portion of the first coupler region 42. In one embodiment, the locking member 46 can comprise a bottom wall 80, a top angled wall 82, a first side wall 84, and a second side wall 86. The first side wall 84 can have a length greater than a length of the second side wall 86, thereby creating the top angled wall 82. The locking member 46 can have a first thickness proximate to the first side wall 84 and can have a second thickness proximate to the second side wall 86. In one embodiment, the first thickness can be greater than the second thickness. In various embodiments, the top angled wall 82 can be angled between about 5 and about 25 degrees, between about 5 and about 20 degrees, between about 5 and about 15 degrees, about 8 degrees, about 8.7 degrees, about 12 degrees, about 12.8 degrees, about 13 degrees, and about 12.1 degrees, for example, between the second side wall 86 and the first side wall 84. In other embodiments, the top angled wall 82 can have any suitable angle between the second side wall 86 and the first side wall 84. In one embodiment, the bottom wall 80 can be angled from the second side wall 86 toward the first side wall 84. Such angling of the bottom wall 80 can allow for easy engagement of the locking member 46 and the receiving slot 70 during sliding of the second coupler region 44 over the first coupler region 42. By providing the angled bottom wall 80, a spring back action of the locking member 46 can be possible and the force required to engage the locking member 46 and the receiving slot 70 can be reduced as compared to the force required when using a locking member having a flat bottom wall 80.

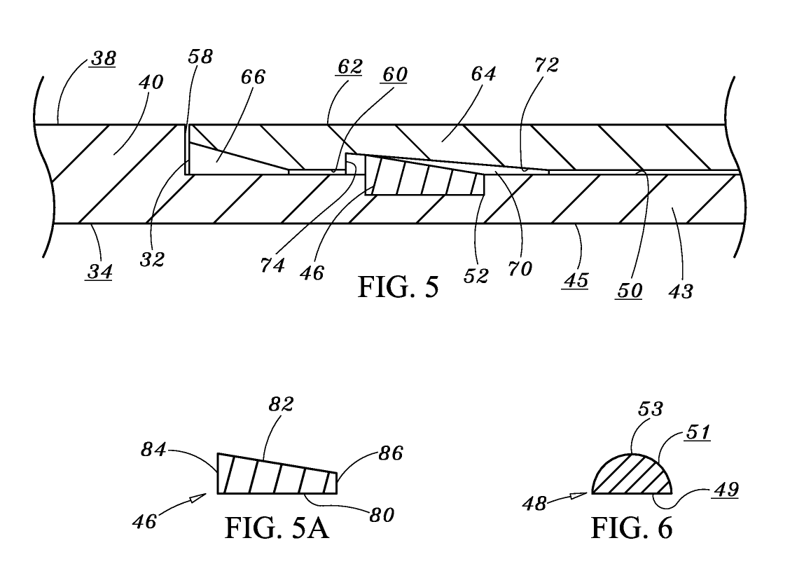

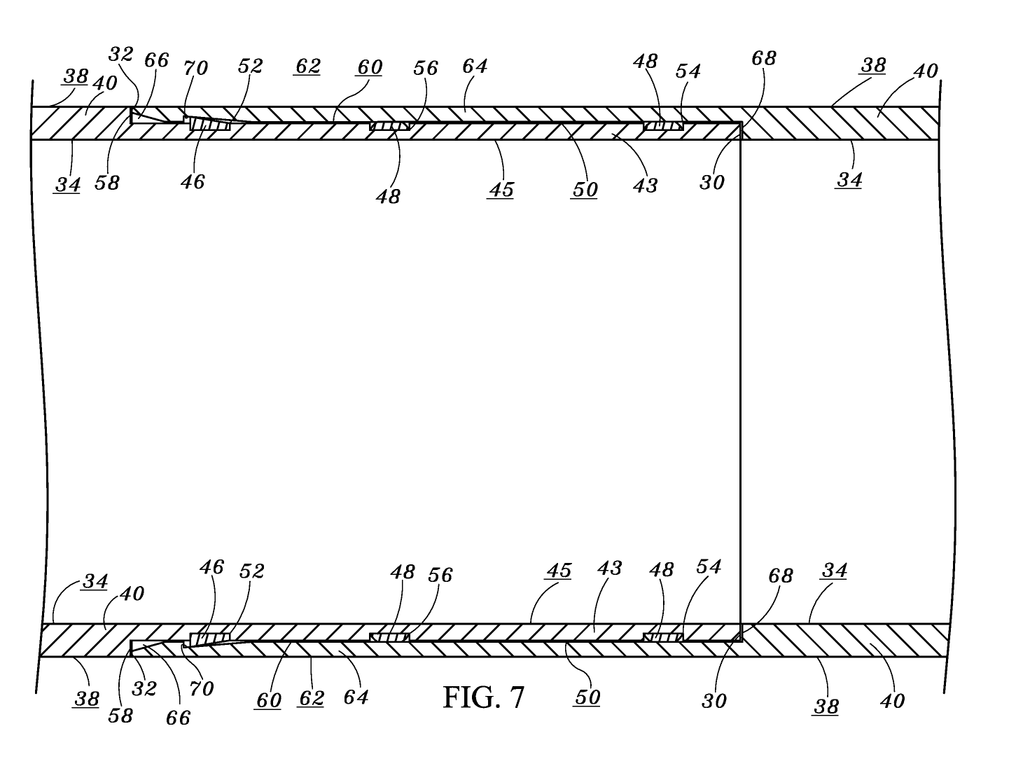

In one embodiment, the top angled wall 82 can be configured to be at least partially positioned within the receiving slot 70. In other embodiments, a top portion of the locking member 46, including the top angled wall 82 can be configured to be at least partially positioned within the receiving slot 70. In various embodiments, the angle of the top angled wall 82 can be the same as, substantially the same as, similar to, or different than the angle of the first receiving slot wall 72. In various example embodiments, the engagement of the locking member 46 with the first groove 52 and the receiving slot 70 are illustrated in FIGS. 5 and 7, where the locking member 46 and the receiving slot 70 are illustrated in cross-section. In one embodiment, the locking member 46 can be optional, along with the first groove 52 and the receiving slot 70. In general, the locking member 46 and the receiving slot 70 can be provided in conduit for use in pushing and pulling pipe bursting operations, microtunnelling operations, and sliplining operations to maintain the first and second conduits 26 and 28 together under the axial tensile forces placed upon the first and second coupler regions 42 and 44 of the first and second conduits 26 and 28, respectively. Although the locking member 46 is discussed above with a top angled wall, it can also have a flat top wall and a substantially rectangular or square cross-sectional profile for certain applications. In such embodiments, the receiving slot 70 can be configured to the profile of the locking member 46. In various embodiments, the locking member 46 can be comprised of PVC, Nylon, steel (e.g., galvanized steel or stainless steel), and/or any other suitable material, for example.

In one embodiment, a locking member can be comprised of a projection extending outwardly from the first outer coupler surface 50. The projection can extend fully or partially about the perimeter of the first outer coupler surface 50. Such a locking member can be attached to or integrally formed with the first outer coupler surface 50 and/or the first coupler region 42 and can be positioned at least partially within the receiving slot 70 of the second coupler region 44 similar to the locking member 46 described above. In such an instance, the first groove 52 defined in the first coupler region 42 can be eliminated.

In one embodiment, referring to FIGS. 2, 3, 6, and 7, one or more sealing members 48 can be used with the first and second conduits 26 and 28. In various embodiments, only one sealing member 48 can be used, while in other embodiments, more than two sealing members 48 can be used. In various embodiments, the locking member can comprise a sealing member or the sealing member can comprise a locking member, for example. In any event, each sealing member 48 can be positioned at least partially within the various grooves in the first coupler region 42. In one embodiment, the sealing members 48 can be positioned at least partially within the second groove 54 and the third groove 56 in the first coupler region 42. Further, a sealing member 48 can be positioned at least partially within the first groove 52, if provided, in embodiments where the locking member 46 is not used.

In one embodiment, a sealing member can be attached to the first outer coupler surface 50, for example. In such an embodiment, a groove may not need to be provided in the first outer coupler surface 50 to receive a portion of the sealing member. Such a sealing member can be engaged with the second inner coupler surface 60 to create a seal similar to that described above with respect to the sealing members 48. In other embodiments, a sealing member can be attached to the second inner coupler surface 60 and engaged with a first outer coupler surface to create a seal, for example.

In one embodiment, the second groove 54 and the third groove 56 can be positioned in close proximity to each other to provide an appropriate seal, when a sealing member 48 is positioned in the second groove 54 and the third groove 56, even if the first conduit 26 is deflected about 1 to about 10 degrees or about 5 degrees from the second conduit 28, for example. Also, such positioning of the second groove 54 relative to the third groove 56, when a sealing member 48 is positioned at least partially within the second groove 54 and the third groove 56, can allow the sealing members 48 to resist movement of the first conduit 26 relative to the second conduit 28. In one embodiment, such positioning can allow a solid seal to be maintained even with about a five percent deflection of the conduits being sealed together, as required by the American Society for Testing and Materials, rule D3212. In one embodiment, the sealing members 48 can be comprised of a rubber, an elastomer, ethylene propylene diene Monomer (M-class) rubber (EPDM rubber), and/or any other suitable materials, for example. The sealing members 48 can prevent, or at least inhibit, a fluid from leaking into and/or out of the conduits 26 and 28. In an embodiment where wires and/or cables are positioned within the conduits 26 and 28, the sealing members 48 can be configured to prevent, or at least inhibit, liquids, such as groundwater for example, from entering the conduits 26 and 28 to maintain the wires and/or cables in a dry, or substantially dry, condition.

In one embodiment, referring to FIG. 6, the one or more sealing members 48 can have a D-shaped cross-sectional profile, as illustrated at least in FIG. 6. The D-shaped cross-sectional profile can allow a solid seal to be made between the one or more sealing members 48 positioned at least partially within one of the various grooves of the first coupler region 42 and the second inner coupler surface 60. In various embodiments, the D-shaped cross-sectional profile can allow the one or more sealing members 48 to be positioned at least partially within one of the various grooves and avoid, or at least inhibit, the one or more sealing members 48 from rolling within the various grooves and/or becoming disengaged with the various grooves during coupling of the first conduit 26 to the second conduit 28, owing to the sealing members' flat, or substantially flat bottom surface 49. An arcuate surface 51, which forms part of the D-shaped cross-sectional profile of the sealing members 48, can also be used to at least inhibit the sealing members 48 from rolling within the grooves and/or becoming disengaged with the various grooves. The greatest width of the D-shaped cross-sectional profile of the one or more sealing members 48 can be less than the width across the various grooves such that the one or more sealing members 48 can be at least partially seated within the grooves and, such that the flat surface 49 can contact a bottom surface of the various grooves. In one embodiment, the D-shaped cross-sectional profile sealing members 48 can be compressed from an apex 53 of the arcuate surface 51 toward the flat surface 49 between about 10 and about 70 percent, between about 20 percent and about 60 percent, between about 30 percent and about 50 percent, and about 40 percent, for example, by the second inner coupler surface 60 of the second coupler region 44 when the second coupler region 44 is slid over the first coupler region 42. Such compression of the sealing members 48 can provide an adequate seal or, in some embodiments, a water-tight seal between the first coupler region 42 and the second coupler region 44.

In one embodiment, referring to FIGS. 2, 3, and 7, the first sealing member 48 can be positioned within the second groove 54 and the second sealing member 48 can be positioned within the third groove 56. The sealing members 48 can be radially stretched or expanded to fit over the first outer coupler surface 50 and then positioned within the various grooves defined in the first outer coupler surface 50. In one embodiment, the sealing members 48 can be comprised of a resilient material, such as rubber, for example. In one embodiment, at least one of the various grooves can have a rectangular or square cross-sectional profile, with an open end defined in the first outer coupler surface 50. Those of skill in the art will recognize that other seals having differently shaped cross-sectional profiles, such as circular, elliptical, or ovate, for example, can also be positioned within the various grooves defined in the first outer coupler surface 50. In one embodiment, grooves (not illustrated) for the sealing members 48 can also be defined in the second inner coupler surface 60, either in addition to or in place of the second and third grooves 54 and 56 in the first outer coupler surface 50.

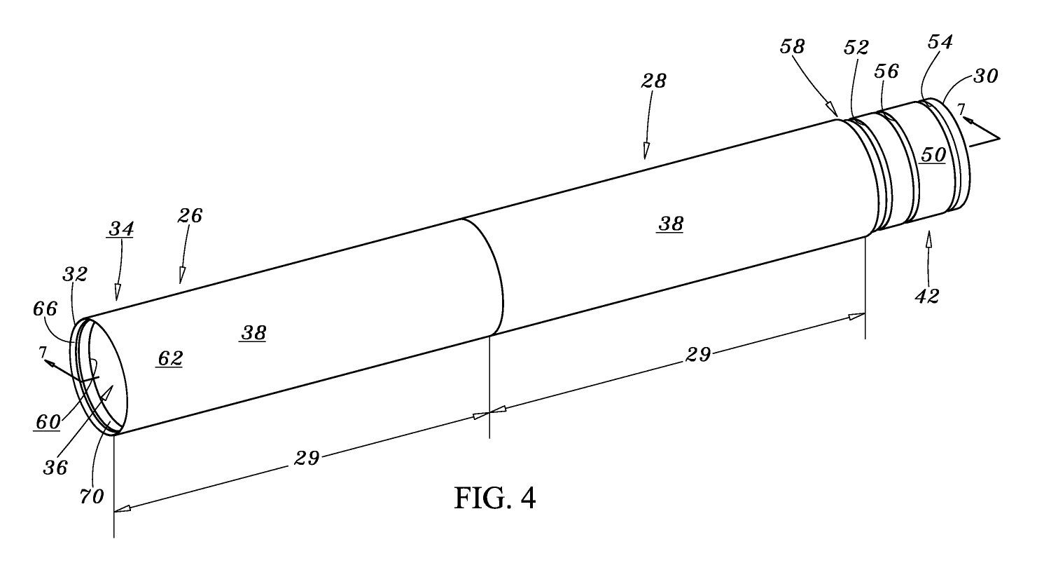

In one embodiment, referring to FIG. 4, the first conduit 26 is illustrated coupled to the second conduit 28. In various embodiments, the first coupler region 42 can be positioned at least partially or fully within the second coupler region 44, as described herein. Such positioning can allow the joined first and second conduits 26 and 28 to have a uniform, or a substantially uniform outer and/or inner perimeter and/or cross-sectional profile throughout their length, including within the coupler regions 42 and 44. In one embodiment, the coupler regions 42 and 44 can create an outer or inner perimeter that is smaller than or slightly larger than the outer or inner surfaces 38 and 34, respectively, of the non-coupler region portions of the first and second conduits 26 and 28. As a result, the first and second conduits 26 and 28 can form a length of conduit having a uniform or substantially uniform outer and inner perimeter and/or a uniform cross-sectional profile throughout its length. Such an outer profile or perimeter can reduce drag or frictional forces created during a pulling or pushing installation or replacement of the conduit and such an inner profile or perimeter can, in some embodiments, provide for more uniform and more laminar flow of a liquid within the first and second conduits 26 and 28. Furthermore, the uniform or substantially uniform inner profile or perimeter can reduce the chance of wires and/or cables being caught or snagged within the first and second conduits 26 and 28 as they are being pushed or pulled therethrough owing to the smooth transition between the coupler regions 42 and 44 and the other portions of the first and second conduits 26 and 28.

In one embodiment, referring to FIGS. 1-7, the present disclosure is directed, in part, to a coupling system configured for use in trenchless applications and configured to permit coupling between the first conduit 26 and the second conduit 28. In various embodiments, the coupling system can comprise the first conduit 26 comprising at least the first coupler region 42. The first coupler region 42 can comprise the first end 30, the first shoulder 58, the first outer coupler surface 50 defined intermediate the first end 30 and the first shoulder 58, and the first inner coupler surface 45. The first coupler region wall 43 can have a first thickness defined between the first outer coupler surface 50 and the first inner coupler surface 45. The first groove 52 can be defined in the first outer coupler surface 50 most distal from the first end 30 and proximal to the first shoulder 58. The first coupler region 42 can comprise the second groove 54 defined in the first outer coupler surface 50 most proximal to the first end 30, and a third groove 56 defined in the first outer coupler surface 50 intermediate the first groove 52 and the second groove 54. The coupling system can comprise the first locking member 46, the first sealing member 48, and the second sealing member 48. In one embodiment, a portion of the locking member 46 can be configured to be positioned at least partially within the first groove 52, a portion of the first sealing member 48 can be configured to be positioned at least partially within the second groove 54, and a portion of the second sealing member 48 can be configured to be positioned at least partially within the third groove 56. In one embodiment, at least one of the first sealing member 48 and the second sealing member 48 can have a D-shaped cross-sectional profile. The second conduit 28 of the coupling system can comprise at least a second coupler region 44 comprising the second end 32, the second shoulder 68, and the second outer coupler surface 62 which can be defined intermediate the second 32 end and the second shoulder 68. The second coupler region 44 can also comprise a second inner coupler surface 60 and the receiving slot 70 defined in the second inner coupler surface 60. The receiving slot 70 can be configured to receive a portion of the locking member 46. The second coupler region 44 can also comprise the second coupler region wall 64 having a second thickness defined between the second outer coupler surface 62 and the second inner coupler surface 60. The sum of the first thickness of the first coupler region wall 43 and the second thickness of the second coupler region wall 64 can be less than, equal to, substantially equal to, or greater than a thickness of a non-coupler region portion of the first conduit 26 or the second conduit 28. As such, the first and second coupler regions 42 and 44 of the first conduit 26 and the second conduit 28, respectively, in some embodiments, may not extend radially outwardly with respect to the outer surface 38 of the first conduit 26 and the outer surface 38 of the second conduit 28 when the first conduit 26 is engaged with the second conduit 28, and may not extend radially inwardly with respect to the inner surface 34 of the first conduit 26 and the inner surface 34 of the second conduit when the first conduit 26 is engaged with the second conduit 28.

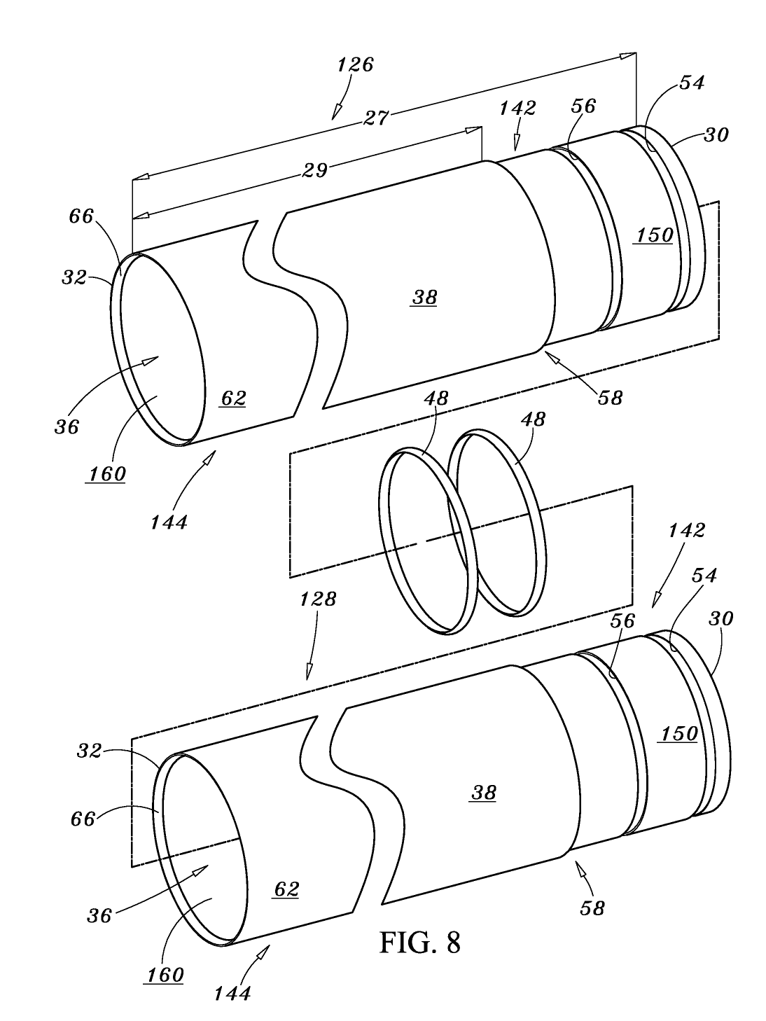

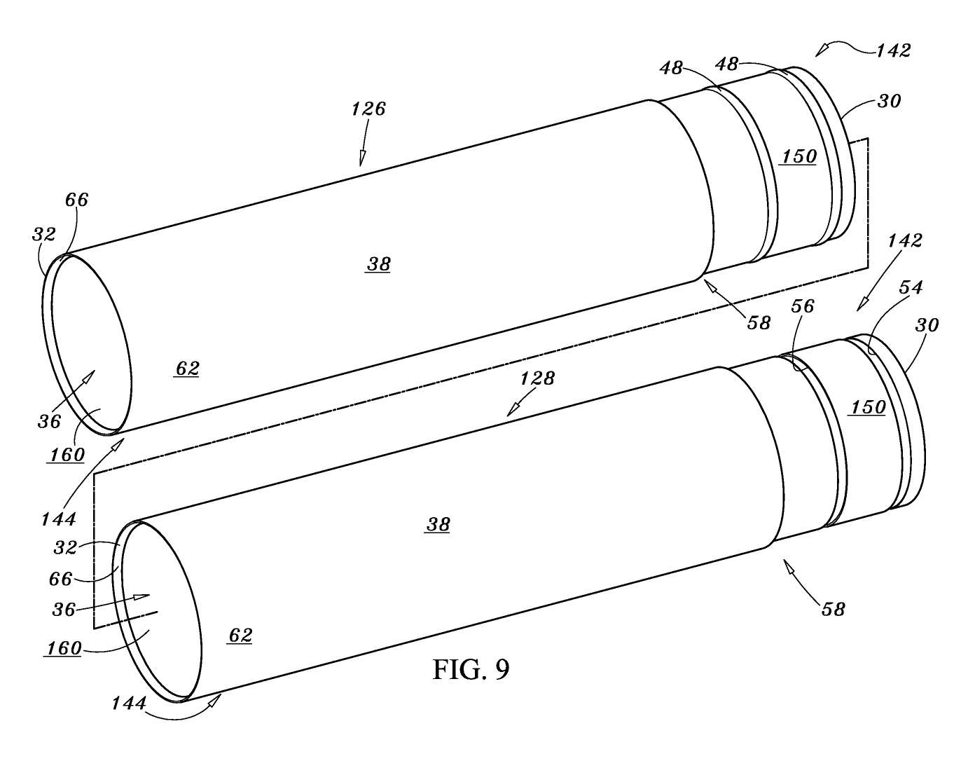

In one embodiment, referring to FIGS. 8 and 9, another example embodiment of the present disclosure is illustrated. In various embodiments, a coupling system can comprise a first conduit 126 and a second conduit 128, each having a first coupler region 142 and a second coupler region 144. In one embodiment, the first and second conduits 126 and 128 can be similar to the first and second conduits 26 and 28 described above, except that the first groove 52 and the receiving slot 70 may not be provided. In one embodiment, the locking member 46 may also not be provided. In such an instance, the sealing members 48 can both seal the first coupler region 142 to the second coupler region 144 and also provide some resistance to an axial force applied to first and second coupler regions 142 and 144 during a conduit pushing or pulling installation, much like the sealing members 48 do in the embodiments discussed above. The elements of the first and second conduits 126 and 128 having reference numerals that are the same as the reference numerals used to describe the first and second conduits 26 and 28 are generally the same as described above and, as such, are not discussed again here for the sake of brevity. The elements of the first and second conduits 126 and 128 having reference numerals that are different (e.g., 150, 160) than the reference numerals used to describe the first and second conduits 26 and 28 denote differences between the first and second conduits 26 and 28 and the first and second conduits 126 and 128.

In various embodiments, the present disclosure is also directed, in part, to a method of coupling a first conduit to a second conduit for use in trenchless applications. The method can comprise providing a first conduit comprising a first coupler region comprising a first end, a first shoulder, a first outer coupler surface defined intermediate the first end and the first shoulder, a first inner coupler surface, and a first coupler region wall having a first thickness defined between the first outer coupler surface and the first inner coupler surface. The method further comprises providing a first groove defined in the first outer coupler surface distal from the first end and proximal to the first shoulder, a second groove defined in the first outer coupler surface proximal to the first end, and a third groove defined in the outer coupler surface intermediate the first groove and the second groove. The method further comprises providing a second conduit comprising a second coupler region comprising a second end, a second shoulder, a second outer coupler surface defined intermediate the second end and the second shoulder, a second inner coupler surface, a receiving slot defined in the second inner coupler surface, and a second coupler region wall having a second thickness defined between the second outer coupler surface and the second inner coupler surface. The method optionally comprises engaging a portion of a locking member into the first groove, engaging a portion of a first sealing member into the second groove, and engaging a portion of a second sealing member into the third groove. The method further comprises moving the second coupler region at least partially over, or fully over, the first coupler region to connect the first conduit to the second conduit, receiving in a receiving slot a portion of the locking member to maintain the first conduit and the second conduit in a coupled state, and forming a conduit with a uniform, or substantially uniform, outer and/or inner perimeter and/or cross-sectional profile throughout its length when the first conduit is joined with the second conduit.

In one embodiment, standard conduit, such as a standard IPSOD conduit having diameters of about 4 inches to about twelve inches, for example, can be machined to create the conduit sections of the present disclosure. Of course, the locking member and the one or more sealing members can also be provided. The conduit can be machined at both ends thereof to create a first coupler region and a second coupler region on each conduit. The machining can be accomplished using any suitable tools or machines, such as a lathe, for example. During the machining, an outer portion near the first end of the conduit can be removed to form the first outer coupler surface and an inner portion near the second end of the conduit can be removed to form the second inner coupler surface. The portion of the conduit near the first end essentially forms a spigot side and the portion of the conduit near the second end essentially forms a socket side. Through creation of the first outer coupler surface, the first shoulder can be created and, likewise, through creation of the second inner coupler surface, the second shoulder can be created. In one embodiment, a first groove, a second groove, and optionally, a third groove, can be formed in a first outer coupler surface. The first groove, the second groove, and the third groove can each receive a locking member or a sealing member. In one embodiment, a projection acting as a portion of a locking member can extend outwardly from and be formed with the first outer coupler surface, such that a separate locking member and an associated locking member groove may not be required. In various embodiments, the projection can extend fully or partially about the perimeter of the first outer coupler surface. Such a projection can be engaged with a receiving slot, such as the receiving slot 70, for example, similar to the locking member 46 discussed above. A chamfered region, and a receiving slot if the locking member is provided, can be formed in the second inner coupler surface during the machining. As a result of the machining, standard conduit can be configured for use in the coupling system of the present disclosure, with the provision of at least one sealing member and optionally a locking member.

The dimensions and values disclosed herein are not to be understood as being strictly limited to the exact numerical values recited. Instead, unless otherwise specified, each such dimension is intended to mean both the recited value and a functionally equivalent range surrounding that value.

While particular non-limiting embodiments of the present disclosure have been illustrated and described herein, those of skill in the art will recognize that various other changes and modifications can be made without departing from the spirit and scope of the present disclosure. It is therefore intended to cover in the appended claims all such changes and modifications that are within the scope of the present disclosure.

What is claimed is:

1. A tubular conduit configured for trenchless applications, the tubular conduit comprising:
an inner surface defining a bore through at least a portion of the tubular conduit;
an outer surface;
a tubular conduit wall having a thickness defined between a portion of the inner surface and a portion the outer surface;
a first end;
a second end;
a first coupler region positioned proximate to the first end of the tubular conduit;
a second coupler region positioned proximate to the second end of the tubular conduit and distal from the first coupler region;
the first coupler region comprising:
a first outer circumferential surface that has a perimeter that is smaller than a perimeter of the outer surface of the tubular conduit;
a first circumferential groove defined in the first outer circumferential surface and configured to receive a portion of a locking member, wherein the first circumferential groove is located a distance X1 from the first end;
a second circumferential groove defined in the first outer circumferential surface and configured to receive a portion of a sealing member, wherein the second circumferential groove is located a distance X2 from the first end, and wherein the distance X1 is greater than the distance X2;
a first inner circumferential surface; and
a first coupler region wall having a first thickness defined between the first outer circumferential surface and the first inner circumferential surface; and
the second coupler region comprising:
a second inner circumferential surface having an inner perimeter that is larger than the perimeter of the first outer circumferential surface of the first coupler region, such that a first outer circumferential surface of a first coupler region of another tubular conduit is configured to fit at least partially within the second inner circumferential surface of the second coupler region;
a circumferentially extending receiving slot defined in the second inner circumferential surface and positioned proximate to the second end, wherein the receiving slot is configured to receive a portion of the locking member;
a second outer circumferential surface; and
a second coupler region wall having a second thickness defined between the second outer circumferential surface and the second inner circumferential surface, wherein the sum of the first thickness and the second thickness is less than or substantially equal to the thickness of the tubular conduit wall.

2. The tubular conduit of claim 1, wherein the receiving slot comprises:
a first receiving slot wall; and
a second receiving slot wall, wherein an acute angle is formed at an intersection of the first receiving slot wall and the second receiving slot wall.

3. The tubular conduit of claim 1, wherein the receiving slot comprises:
a receiving slot wall extending inwardly from the second inner circumferential surface of the second coupler region, the receiving slot wall comprising:
a first portion spaced a first distance from the second inner circumferential surface; and
a second portion spaced a second distance from the second inner circumferential surface;
wherein the second distance is at least twice as great as the first distance, and wherein the second portion is located closer to the second end than the first portion.

4. The tubular conduit of claim 1, wherein the depth of the receiving slot relative to the second inner circumferential surface increases based on the proximity of a portion of the receiving slot to the second end.

5. The tubular conduit of claim 1, wherein the first coupler region comprises a third circumferential groove configured to receive a portion of one of a second locking member and a second sealing member, wherein the third circumferential groove is located a distance X3 from the first end, and wherein the distance X3 is less than the distance X1, but greater than the distance X2.

6. The tubular conduit of claim 1, wherein the first coupler region comprises a shoulder at a location most distal from the first end, and wherein a second end of a second coupler region of another tubular conduit is configured to be positioned in close proximity to the shoulder when the other tubular conduit is coupled to the tubular conduit.

7. The tubular conduit of claim 1, wherein the second coupler region comprises a shoulder at a location most distal from the second end, and wherein a first end of a first coupler region of another tubular conduit is configured to be positioned in close proximity to the shoulder when the other tubular conduit is coupled to the tubular conduit.

8. The tubular conduit of claim 1, wherein the second coupler region comprises a circumferentially extending chamfered region proximate to the second end, and wherein the second coupler region wall has a minimum thickness at the second end owing to the chamfered region.

9. The tubular conduit of claim 1, wherein the first circumferential groove and the second circumferential groove comprise a rectangular cross-sectional profile with one open side.

10. The tubular conduit of claim 1, wherein the tubular conduit comprises a polyvinyl chloride material and has an outer diameter in the range of about four inches to about twenty-four inches.

11. A conduit configured for trenchless applications, the conduit comprising:
an inner surface defining a bore through at least a portion of the conduit;
an outer surface;
a conduit wall having a thickness defined between a portion of the inner surface and a portion the outer surface;
a first coupler region positioned proximate to a first end of the conduit;
a second coupler region positioned proximate to a second end of the conduit;
the first coupler region comprising:
a first outer coupler surface that has a perimeter that is smaller than a perimeter of the outer surface of the conduit;
a first groove defined in the first outer coupler surface and configured to receive a portion of a first sealing member, wherein the first groove is located a first distance from the first end;
a second groove defined in the first outer coupler surface and configured to receive a portion of a second sealing member, wherein the second groove is located a second distance from the first end, and wherein the first distance is greater than the second distance;
a first inner coupler surface; and
a first coupler region wall having a first thickness defined between the first outer coupler surface and the first inner coupler surface; and
the second coupler region comprising:
a second inner coupler surface having an inner perimeter that is larger than the perimeter of the first outer coupler surface of the first coupler region, such that a first outer coupler surface of a first coupler region of another conduit is configured to fit at least partially within the second inner coupler surface of the second coupler region;
a second outer coupler surface;
a second coupler region wall having a second thickness defined between the second outer coupler surface and the second inner coupler surface, wherein the sum of the first thickness and the second thickness is less than or substantially equal to the thickness of the conduit wall; and
a chamfered region positioned proximate to the second end, wherein the second coupler region wall has a minimum thickness at the second end owing to the chamfered region.

12. The conduit of claim 11, wherein the conduit is tubular.

13. The conduit of claim 11, wherein the second coupler region comprises a circumferentially extending receiving slot defined in the second inner coupler surface and configured to receive a locking member.

14. The conduit of claim 11, wherein the first coupler region comprises a shoulder at a location most distal from the first end, and wherein a second end of a second coupler region of another conduit is configured to be positioned in close proximity to the shoulder when the other conduit is coupled to the conduit.

15. The conduit of claim 11, wherein the second coupler region comprises a shoulder at a location most distal from the second end, and wherein a first end of a first coupler region of another conduit is configured to be positioned in close proximity to the shoulder when the other conduit is coupled to the conduit.

16. A coupling system configured for use in trenchless applications and configured to permit coupling of a first conduit to a second conduit, the coupling system comprising:
the first conduit comprising:
a first coupler region comprising:
a first end;
a first shoulder;
a first outer coupler surface defined intermediate the first end and the first shoulder;
a first inner coupler surface;
a first coupler region wall having a first thickness defined between the first outer coupler surface and the first inner coupler surface;
a first groove defined in the first outer coupler surface and positioned distal from the first end;
a second groove defined in the first outer coupler surface and positioned proximal to the first end; and
a third groove defined in the first outer coupler surface intermediate the first groove and the second groove;
a locking member, wherein a portion of the locking member is configured to be positioned in the first groove;
a first sealing member, wherein a portion of the first sealing member is configured to be positioned in the second groove;
a second sealing member, wherein a portion of the second sealing member is configured to be positioned in the third groove, and wherein at least one of the first sealing member and the second sealing member has a D-shaped cross-sectional profile; and
the second conduit comprising:
a second coupler region comprising:
a second end;
a second shoulder;
a second outer coupler surface defined intermediate the second end and the second shoulder;
a second inner coupler surface;
a receiving slot defined in the second inner coupler surface, wherein the receiving slot is configured to receive a portion of the locking member; and
a second coupler region wall having a second thickness defined between the second outer coupler surface and the second inner coupler surface;
wherein the sum of the first thickness and the second thickness is less than or substantially equal to a thickness of a non-coupler region of the first conduit or the second conduit such that the first and second coupler regions of the first conduit and the second conduit are substantially flush with an outer surface of the first conduit and an outer surface of the second conduit when the first conduit is engaged with the second conduit.

17. The system of claim 16, wherein the first shoulder is positioned proximate to the second end when the first conduit is engaged with the second conduit.

18. The system of claim 16, wherein the locking member comprises a top angled wall configured to be at least partially positioned within the receiving slot, wherein the locking member has a first height at a first end and a second height at a second end, and wherein the first height is greater than the second height.

19. The system of claim 16, wherein the locking member comprises:
a first end; and
a second end, wherein a gap is defined in the locking member intermediate the first end and the second end.

20. The system of claim 16, wherein the receiving slot comprises:
a receiving slot wall extending inwardly from the second inner coupler surface of the second coupler region, the receiving slot wall comprising:
a first portion spaced a first distance from the second inner coupler surface; and
a second portion spaced a second distance from the second inner coupler surface;
wherein the second distance is at least twice as great as the first distance; and
wherein the second portion is located closer to the second end than the first portion.
